(19) United States
(12) Patent Application Publication
(10) Pub. No.: US 2012/0084640 A1
(43) Pub. Date: Apr. 5, 2012

(54) RESOLVING PAGE REFERENCES IN LAYOUT DEPENDENT DOCUMENTS

(75) Inventor: Jason James Grams, Broomfield, CO (US)

(73) Assignee: KONICA MINOLTA SYSTEMS LABORATORY INC., Huntington Beach, CA (US)

(21) Appl. No.: 12/895,592

(22) Filed: Sep. 30, 2010

(51) Int. Cl. G06F 17/00

(52) U.S. Cl. 715/235

(57) ABSTRACT

A method for resolving references in electronic documents (EDs), including: obtaining an ED having a reference to an item; generating, based on the ED, an intermediate document (ID) for input to a layout engine; identifying an entry having an initial value for the reference; calculating, during a first rendering of the ED, a first page having the item based on the ID and the initial value substituted for the reference; populating the entry with a first page number corresponding to the first page; calculating, during a second rendering of the ED, a second page having the item based on the first page number substituted for the reference; populating the entry with a second page number corresponding to the second page; and generating, in response to the first page number equaling the second page number, a first rendered document based on the second page number substituted for the reference.

### BACKGROUND

Documents stored in office productivity based formats typically do not have a set page layout. As a result, the page upon which an item of the document can appear is entirely dependent upon the method used to lay out the textual data. In addition, certain components of these documents can contain references to other portions of the document. In order for these references to be accurate, the page(s) upon which the referenced items occur needs to be known when the reference is processed.

In office-productivity applications, this information is known implicitly, as the entire document is available for processing at any given time. However, in a printer, the document must be processed linearly, and therefore references to items that occur after the references might not accurately identify the referenced items.

### SUMMARY

In general, in one aspect, the invention relates to a method for resolving references in electronic documents (EDs). The method comprising: obtaining an ED comprising a reference to an item within the ED; generating, based on the ED, an intermediate document (ID) for input to a layout engine; identifying, within a data structure external to the ID, an entry comprising an initial value for the reference; calculating, by the layout engine and during a first rendering of the ED, a first page comprising the item based on the ID and the initial value substituted for the reference; populating the entry with a first page number corresponding to the first page; calculating, by the layout engine and during a second rendering of the ED, a second page comprising the item based on the ID and the first page number substituted for the reference; populating the entry with a second page number corresponding to the second page; and generating, using the layout engine and in response to the first page number equaling the second page number in the entry, a first rendered document (RD) based on the ID and the second page number substituted for the reference.

In general, in one aspect, the invention relates to a non-transitory computer readable storage medium storing instructions for resolving references in electronic documents (EDs). The instructions comprising functionality to: obtain an ED comprising a reference to an item within the ED; generate, based on the ED, an intermediate document (ID) for input to a layout engine; identify, within a data structure external to the ID, an entry comprising an initial value for the reference; submit, to the layout engine, the ID and the initial value substituted for the reference, wherein the layout engine calculates a first page comprising the item during a first rendering of the ED; populate the entry with a first page number corresponding to the first page; submit, to the layout engine, the ID and the first page number substituted for the reference, wherein the layout engine calculates a second page comprising the item during a second rendering of the ED; and populate the entry with a second page number corresponding to the second page; and generate, in response to the first page number equaling the second page number, a rendered document (RD) based on the ID and the second page number substituted for the reference.

In general, in one aspect, the invention relates to A system for resolving references in electronic documents (EDs). The system comprising: a hardware processor; a convertor module executing on the hardware processor and configured to generate an intermediate document (ID) based on an electronic document (ED) comprising a reference to an item within the ED; a layout engine executing on the hardware processor and configured to: calculate, during a first rendering of the ED, a first page comprising the item based on the ID and an initial value substituted for the reference; and calculate, during a second rendering of the ED, a second page comprising the item based on the ID and a first page number corresponding to the first page substituted for the reference; and a data structure external to the ID and comprising an entry storing the initial value, the first page number, and a second page number corresponding to the second page, wherein the layout engine is further configured to generate a rendered document (RD) based on the ID and the second page number substituted for the reference in response to the first page number equaling the second page number.

Other aspects of the invention will be apparent from the following description and the appended claims.

### BRIEF DESCRIPTION OF DRAWINGS

FIG. 1 shows a system in accordance with one or more embodiments of the invention.

FIG. 2 shows a flowchart in accordance with one or more embodiments of the invention.

FIGS. 3, 4A, and 4B show examples in accordance with one or more embodiments of the invention.

FIG. 5 shows a computer system in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention provide a system and method for resolving references in electronic documents (EDs). Specifically, prior to the processing of an ED by a layout engine, the reference is substituted with a preciously recorded page number. The previously recorded page number corresponds to the page on which the referenced item was placed during a previous rendering of the ED. Following the processing of the ED by the layout engine, the page number of the latest page on which the referenced item was placed is compared to the substituted value. If no match exists, the process is repeated but using the latest page number as a substitution for the reference.

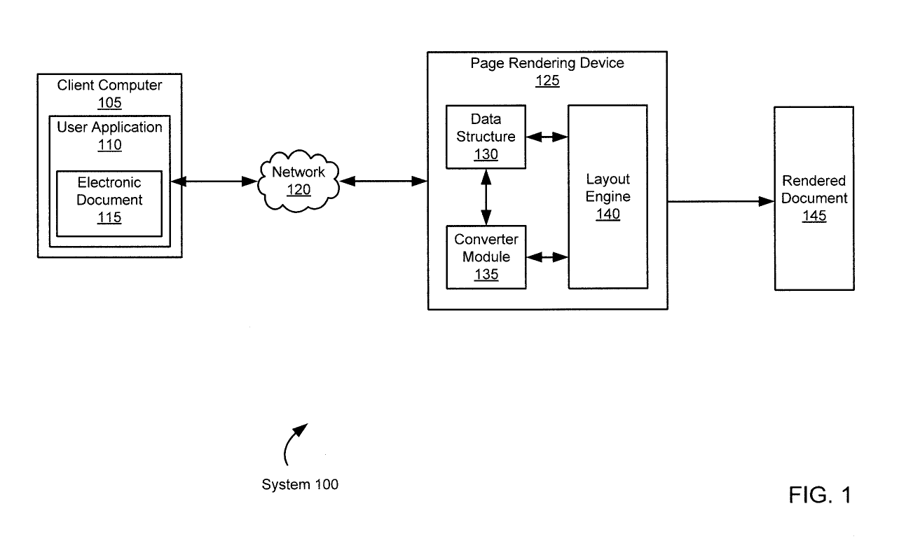

FIG. 1 shows a system (100) in accordance with one or more embodiments of the invention. As shown in FIG. 1, the system (100) has multiple components including a page rendering device (125) and a client computer (105). The page rendering device (125) may be, for example, a printer, an electronic reader, etc. The client computer (105) may be a personal computer (PC), a desktop computer, a mainframe, a server, a telephone, a kiosk, a cable box, a personal digital assistant (PDA), a mobile phone, a smart phone, etc. There may be a direct connection (e.g., universal serial bus (USB) connection) between the client computer (105) and the page rendering device (125). Alternatively, the client computer (105) and the page rendering device (125) may be connected using a network (120) having wired and/or wireless segments. In one or more embodiments of the invention, the page rendering device (125) is part of a photocopier (not shown). In one or more embodiments of the invention, the page rendering device (125) and the client computer (105) are part of a photocopier (not shown).

In one or more embodiments of the invention, the PRD (125) is located on the client computer (105). In such embodiments, the PRD (125) may correspond to any combination of hardware and software on the client device (105) for rendering an ED.

In one or more embodiments of the invention, the client computer (105) executes the user application (110). The user application (110) is a software application operated by a user and configured to obtain, input, generate, and/or print an electronic document (ED) (e.g., Electronic Document (115)) having any number of pages. Accordingly, the user application (110) may be a word-processing application, a spreadsheet application, a desktop publishing application, a graphics application, a photograph printing application, an Internet browser, etc. The user application (110) may generate new EDs and/or obtain previously saved EDs.

In one or more embodiments of the invention, a section of the ED (115) includes one or more references to items within the ED (115). When the rendered document (145) is generated based on the ED (115), the one or more references will be replaced with the page numbers of the pages in the rendered document (145) on which the referenced items are placed. For example, the ED (115) may include a table of contents (TOC) section. The TOC section will include references to the subheadings and chapter subtitles of the ED (115). When the rendered document (145) is generated based the ED (115), the references will be replaced with the page numbers of the pages in the rendered document (145) on which the subheadings and chapter subtitles are placed.

In one or more embodiments of the invention, the ED (115) is represented/defined using a document markup language (e.g., ODF, OOXML, etc.). Accordingly, the references may be recorded as attributes within the tags of the document markup language. Further, the page breaks created by the user application (110) for the ED (115) may also be recoded within the tags of the document markup language.

In one or more embodiments of the invention, the page rendering device (125) includes a layout engine (140). The layout engine (140) is configured to calculate the positions/placement of the columns, paragraphs, sentences, words, letters, subheadings, subtitles, images, etc. of the ED (115) on a readable medium (e.g., paper, transparencies, microfilm, computer monitor, an electronic reader, etc.).

In one or more embodiments of the invention, the page rendering device (125) includes a convertor module (135). The convertor module (135) is configured to transform (i.e., convert) the ED (115) into an intermediate form or intermediate document (ID) suitable for consumption by the layout engine (140). Further, the convertor module (116) may substitute references in the intermediate form with page numbers before the intermediate form is consumed by the layout engine (140).

In one or more embodiments of the invention, the data structure (130) comprises entries corresponding to each reference in the ED (115). Each entry may have multiple values for a reference. These multiple values (e.g., PN₀,PN₁, PN₂, PN₃, . . . ) correspond to the page numbers of the pages on which the referenced item was placed during previous renderings of the ED (115) by the layout engine (140). In one or more embodiments of the invention, the initial value (i.e., PN₀) may be estimated based on the page breaks set by the user application (110)

In one or more embodiments of the invention, in order for the references to be accurate, the page on which the referenced item is placed needs to be known when the reference is processed by the layout engine (140). However, in the page rendering device (125), the ED (115) is processed linearly and any references to items that occur after the references (e.g., subheadings after the TOC section) might not accurately identify the page numbers. Accordingly, when the reference is processed by the layout engine (140), a page number previously recorded in the data structure (130) following a previous rendering is substituted for the reference. Once the layout engine (140) renders the document, the substituted value can be compared with the actual page number of the page on which the referenced item was placed. If no match exists, the process can be repeated but using the latest page number as a substitute for the reference.

In one or more embodiments of the invention, the page rendering device (125) may also contain a GUI (not shown) for displaying information associated with the printing process. The GUI may be viewed in a web browser, an application window, on a display of the page rendering device (125), and the like. The GUI may be viewed in these display technologies by a user of user application (110). The GUI may include standard display elements, including video, audio, and text, as well as interface technologies not limited to text submission on forms, voice capture, and user gesture interpretation. In one or more embodiments of the invention there may be various other display technologies used to view the GUI.

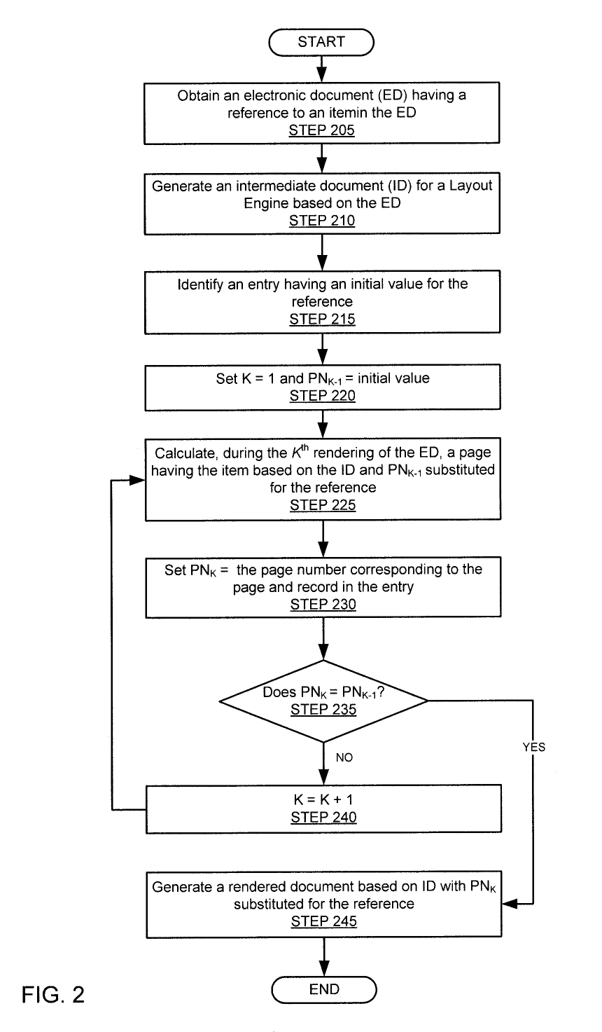

FIG. 2 shows a flowchart in accordance with one or more embodiments of the invention. The process shown in FIG. 2 may be used, for example, with the system of FIG. 1 to resolve references in electronic documents. The sequence of steps shown in FIG. 2 may differ among embodiments of the invention, and one or more of the steps may be performed in parallel and/or may be optional.

In STEP 205, an electronic document (ED) is obtained. The ED contains a reference to an item in the ED. For example, the reference may be a pointer to a chapter title or subheading within in the ED. Further, the reference may be located within the ED's table of contents. In one or more embodiments of the invention, the ED is represented/defined using a document markup language (e.g., ODF, OOXML, etc.). Accordingly, the properties of the ED and the reference(s) in the ED may be recorded as attributes within the tags of the document markup language.

In STEP 210, an intermediate document (ID) is generated (e.g., by the converter module (135), discussed above in reference to FIG. 1). An ID is a document suitable for consumption by a layout engine. The ID may contain the content of the ED, but with unresolved references.

In STEP 215, an entry for the reference is identified in a data structure external to the ED and the ID. The entry includes an initial value for the reference. For example, the entry may have an initial value of “3”. In one or more embodiments of the invention, the initial value may be estimated based on page breaks set by a user application (e.g., User Application (110), discussed above in reference to FIG. 1).

In STEP 220, the counter K is initialized to K=1, and the value of page number_{K-1} (i.e., PN_{K-1}) is set to PN_{K-1}=PN₀=initial value.

In STEP 225, the page having the referenced item is calculated.

Specifically, the calculation is performed (e.g., by the layout engine (140), discussed above in reference to FIG. 1) during a K^{th} rendering of the ED prior to which PN_{K-1} is substituted for the reference.

In STEP 230, the page number corresponding to the calculated page is recorded in the entry. Further, the variable PN_{K} is set to PN_{K}=page number.

In STEP 235, it is determined whether PN_{K} equals PN_{K-1}. When it is determined that PN_{K} equals PN_{K-1}, the process proceeds to STEP 245. Otherwise, when it is determined that PN_{K} does not equals PN_{K-1}, the process proceeds to STEP 240. In STEP 240, counter K is incremented by one, and the process returns to STEP 225.

In STEP 245, a rendered document is generated. The rendered document is generated based on the ID with PN_{K} substituted for the reference. Generation of a rendered document may include printing of the rendered document by a page rendering device (e.g. a printer). Those skilled in the art will appreciate that there may be various other steps performed that have not been described above.

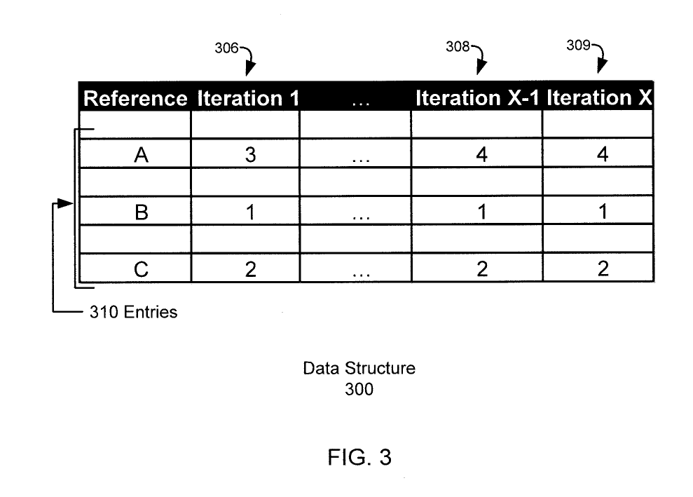

FIG. 3 shows a data structure (300) in accordance with one or more embodiments of the invention. The data structure (300) may be essentially the same as the data structure (130), discussed above in reference to FIG. 1. Each entry (310) corresponds to a different reference in the ED. Further, each column corresponds to a different rendering of the ED by the layout engine (i.e., a different iteration of the process shown in FIG. 2). As shown in FIG. 3, following the first iteration (306), the item referenced by reference A was calculated to be on page 3 of the rendered document. Following the X−1^{th} iteration (308), the item referenced by reference A was calculated to be on page 4 of the rendered document. Following the X^{th} iteration (309), the item referenced by the reference A was still calculated to be on page 4 of the rendered document. In other words, it took X iterations (i.e., X renderings of the ED) to finalize the location of the item referenced by reference A. In contrast, the pages having the items referenced by reference B and reference C were correctly identified following the very first iteration. In one or more embodiments of the invention, a rendered document (e.g. a hardcopy document) is generated when the location of the items referenced by the references are finalized (i.e., the page numbers have remained constant over at least the last two iterations) or the number of iterations has exceeded a predefined limit (e.g., 11 iterations)).

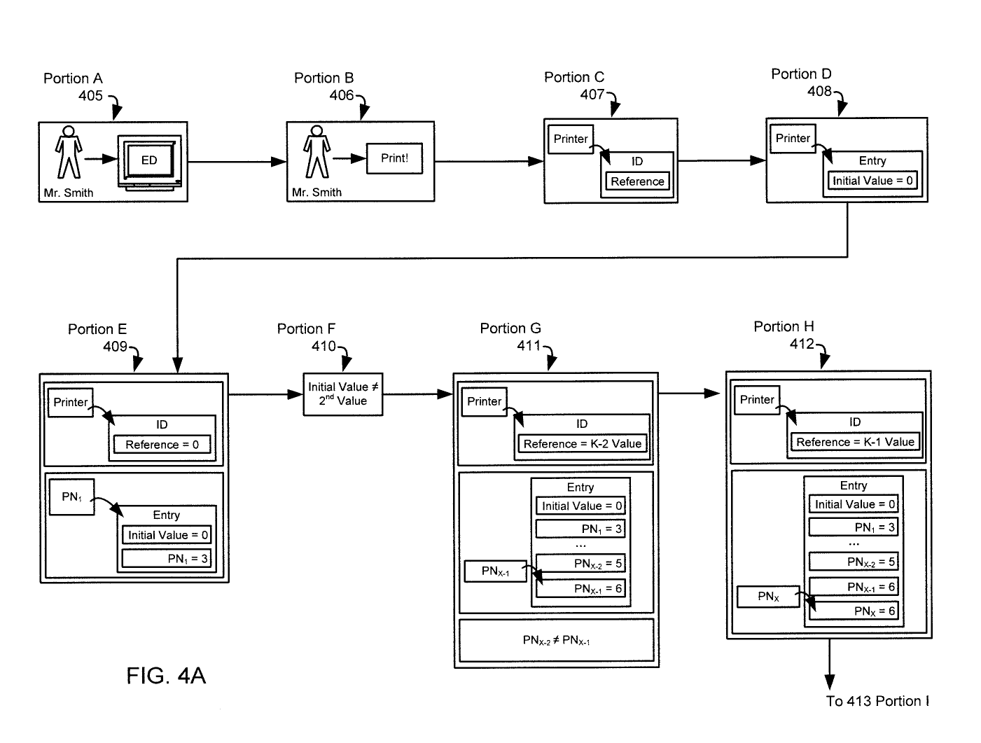

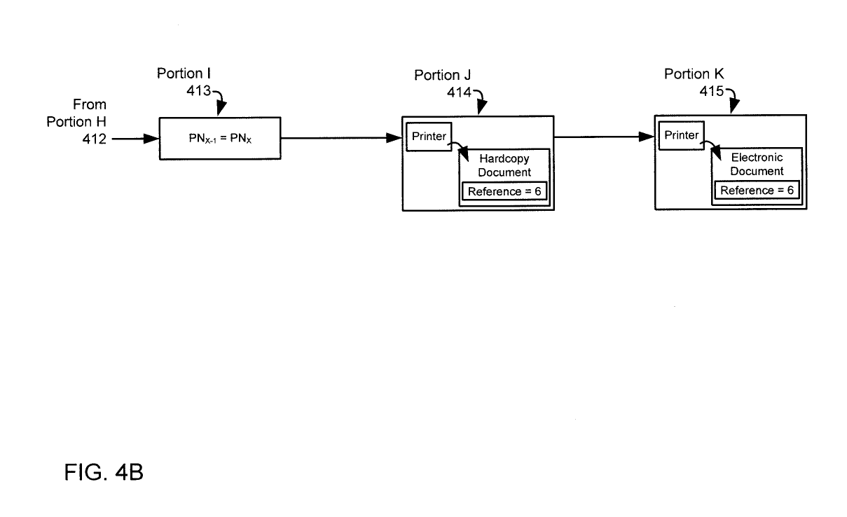

FIG. 4A shows an example in accordance with one or more embodiments of the invention. The example shown in FIG. 4A may be used, for example, with the system (100), to resolve references in electronic documents. The portions shown in FIG. 4A may differ among embodiments of the invention, and one or more of the portions may be performed in parallel and/or may be optional.

In portion A (405), Mr. Smith authors an electronic document (ED) in a user application on a client computer. The ED may be, for example, a word processing document. The user application may be, for example, a word processor. The client computer may be, for example, Mr. Smith's desktop computer.

In portion B (406), Mr. Smith submits a print command for the ED. The print command may be communicated by the user application to a printer (i.e. a page rendering device) over a network. In this example, the print command initializes the print process, and offloads the rendering process to a printer, instead of performing the rendering on the client computer.

In portion C (407), the printer generates, based on the ED, an ID containing a reference to an item in the ED. The item may be located anywhere in the ID, and the reference to the item may be located in, for example, a table of contents of the ID.

In portion D (408), the printer creates an entry for the reference, and stores an initial value for the reference. The entry may be stored in a data structure on the printer, and the initial value may be a randomly generated number or a constant value (e.g. “0”). This is the value that will be initially substituted for the reference in the ID during the initial rendering.

In portion E (409), during an initial rendering of the ID with the initial value substituted for the reference, the printer calculates/identifies the page number (i.e., PN₁) of the page on which the item is placed and records the page number in the entry. PN₁ may be, for example, be “3”.

In portion F (410), the printer determines that the initial value does not equal PN₁ (i.e., initial value=0≠PN=3). These values are different because the page on which the referenced item is located has changed. This may occur during the rendering process when, for example, content is expanded, references are filled, and due to various other factors.

In portion G (411), during a subsequent rendering with PN_{X-2} substituted for the reference, the printer identifies the referenced item place on the page having page number PN_{X-1}. PN_{X-1} is then recorded in the entry. The printer determines that PN_{X-1} does not equal PN_{X-2} and initiates another rendering.

In portion H (412), during the X^{th} rendering with PN_{X-1} substituted for the reference, the printer identifies the referenced item placed on the page having page number PN_{X}. PN_{X} is then recorded in the entry. As shown in portion H (412), PN_{X-1}=PN_{X}=6. This corresponds to the scenario where the referenced item's location has been finalized.

FIG. 4B shows an example in accordance with one or more embodiments of the invention. The example shown in FIG. 4B may be used, for example, with the system (100), to resolve references in electronic documents. The portions shown in FIG. 4B may differ among embodiments of the invention, and one or more of the portions may be performed in parallel and/or may be optional.

In portion I (413), the printer determines that PN_{X-1}=PN_{X}=6. As discussed above, this corresponds to the scenario where the referenced item's location is finalized.

In portion J (414), the printer generates a hardcopy document (i.e. a rendered document) based on the ID and PN_{X} substituted for the reference. Specifically, in this example, the hardcopy document is generated (and printed) with the reference set to “6”.

In portion K (415), the printer modifies the ED to include PN_{X} as a potential value for the reference. In this example, the printer modifies the ED to contain the value of “6” for the reference. If an attempt is made at a future time to print the ED, the initial value for the reference may be set to “6” in order to eliminate or at least reduce the number of iterations needed to generate the hardcopy document.

The printer may also use other similar methods for immediately identifying the correct value of the reference. For example, the printer may identify a set of page breaks in the ED, and set the initial values of the references to the values of the page breaks. This may produce initial values that are closer to the final values of references, and may require less rendering iterations to identify those final values. Page breaks are typically very sensitive to minor changes in layout characteristics, and may differ between different user applications. Page breaks may, however, provide for an approximation as to which page of a document contain a certain item that is referenced. The use of page breaks to set initial values may be used as part of the rendering process, or may be used in place of it. For example, if complete accuracy in the determination of values is not required, the page break values may be used in place of identifying the values of references during the rendering process. This may eliminate the need to iterate through the ID multiple times in order to identify reference values. Otherwise, values derived from page breaks may be used as initial values with which to start the rendering process.

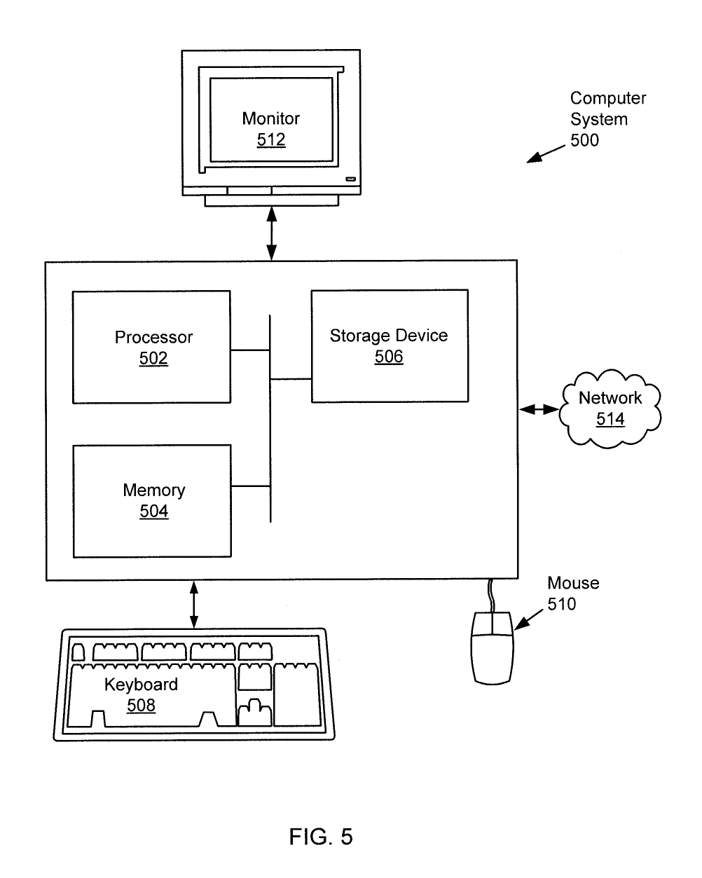

Embodiments of the invention may be implemented on virtually any type of computer regardless of the platform being used. For example, as shown in FIG. 5, computer system (500) includes one or more processor(s) (502), associated memory (504) (e.g. random access memory (RAM), cache memory, flash memory, etc.), storage device (506) (e.g. a hard disk, an optical drive such as a compact disk drive or digital video disk (DVD) drive, a flash memory stick, etc.), and numerous other elements and functionalities typical of today's computers (not shown). In one or more embodiments of the invention, processor (502) is hardware. For example, the processor may be an integrated circuit. Computer system (500) may also include input means, such as keyboard (508), mouse (510), or a microphone (not shown). Further, computer system (500) may include output means, such as monitor (512) (e.g. a liquid crystal display (LCD), a plasma display, or cathode ray tube (CRT) monitor). Computer system (500) may be connected to network (514) (e.g. a local area network (LAN), a wide area network (WAN) such as the Internet, or any other type of network) via a network interface connection (not shown). In one or more embodiments of the invention, many different types of computer systems exist, and the aforementioned input and output means may take other forms. Generally speaking, computer system (500) includes at least the minimal processing, input, and/or output means necessary to practice embodiments of the invention.

Further, in one or more embodiments of the invention, one or more elements of the aforementioned computer system (500) may be located at a remote location and connected to the other elements over a network. Further, embodiments of the invention may be implemented on a distributed system having a plurality of nodes, where each portion of the invention (e.g. data structure, converter module, layout engine) may be located on a different node within the distributed system. In one embodiment of the invention, the node corresponds to a computer system. Alternatively, the node may correspond to a processor with associated physical memory. The node may alternatively correspond to a processor or micro-core of a processor with shared memory and/or resources. Further, software instructions in the form of computer readable program code to perform embodiments of the invention may be stored, temporarily or permanently, on a non-transitory computer readable storage medium, such as a compact disc (CD), a diskette, punch cards, a tape, memory, or any other computer readable storage device.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A method for resolving references in electronic documents (EDs), comprising:
obtaining an ED comprising a reference to an item within the ED;
generating, based on the ED, an intermediate document (ID) for input to a layout engine;
identifying, within a data structure external to the ID, an entry comprising an initial value for the reference;
calculating, by the layout engine and during a first rendering of the ED, a first page comprising the item based on the ID and the initial value substituted for the reference;
populating the entry with a first page number corresponding to the first page;
calculating, by the layout engine and during a second rendering of the ED, a second page comprising the item based on the ID and the first page number substituted for the reference;
populating the entry with a second page number corresponding to the second page; and
generating, using the layout engine and in response to the first page number equaling the second page number in the entry, a first rendered document (RD) based on the ID and the second page number substituted for the reference.

2. The method of claim 1, wherein the ED is defined using an extensible markup language.

3. The method of claim 1, wherein the ED is obtained by a page rendering device (PRD) and wherein the PRD comprises the layout engine and the data structure.

4. The method of claim 1, further comprising:
identifying, within the ED, an occurrence of a page break associated with a user application; and
setting, before calculating the first page, the initial value in the entry based on the page break.

5. The method of claim 1, further comprising:
modifying, in response to the first page number equaling the second page number, the ED to include the second page number for the reference; and
generating a second RD for the ED using the second page number as the initial value.

6. The method of claim 1, wherein the data structure is an array.

7. The method of claim 1, wherein the ED comprises a table of contents, and wherein the table of contends comprises the reference.

8. A non-transitory computer readable storage medium storing instructions for resolving references in electronic documents (EDs), the instructions comprising functionality to:
obtain an ED comprising a reference to an item within the ED;
generate, based on the ED, an intermediate document (ID) for input to a layout engine;
identify, within a data structure external to the ID, an entry comprising an initial value for the reference;
submit, to the layout engine, the ID and the initial value substituted for the reference, wherein the layout engine calculates a first page comprising the item during a first rendering of the ED;
populate the entry with a first page number corresponding to the first page;
submit, to the layout engine, the ID and the first page number substituted for the reference, wherein the layout engine calculates a second page comprising the item during a second rendering of the ED; and
populate the entry with a second page number corresponding to the second page; and
generate, in response to the first page number equaling the second page number, a rendered document (RD) based on the ID and the second page number substituted for the reference.

9. The non-transitory computer readable storage medium of claim 8, wherein the ED is defined using an extensible markup language.

10. The non-transitory compute readable storage medium of claim 8, wherein the ED is obtained by a page rendering device (PRD) and wherein the PRD comprises the layout engine and the data structure.

11. The non-transitory computer readable storage medium of claim 8, the instructions further comprising functionality to:
identify, within the ED, an occurrence of a page break associated with a user application; and
set, before calculating the first page, the initial value in the entry based on the page break.

12. The non-transitory computer readable storage medium of claim 8, the instructions further comprising to:
modify, in response to the first page number equaling the second page number, the ED to include the second page number for the reference; and
generate a second RD for the ED using the second page number as the initial value.

13. The non-transitory computer readable storage medium of claim 8, wherein the data structure is an array.

14. The non-transitory computer readable storage medium of claim 8, wherein the ED comprises a table of contents, and wherein the table of contents comprises the reference.

15. A system for resolving references in electronic documents (EDs), comprising:
a hardware processor;
a convertor module executing on the hardware processor and configured to generate an intermediate document (ID) based on an electronic document (ED) comprising a reference to an item within the ED;
a layout engine executing on the hardware processor and configured to:
calculate, during a first rendering of the ED, a first page comprising the item based on the ID and an initial value substituted for the reference; and
calculate, during a second rendering of the ED, a second page comprising the item based on the ID and a first page number corresponding to the first page substituted for the reference; and
a data structure external to the ID and comprising an entry storing the initial value, the first page number, and a second page number corresponding to the second page,
wherein the layout engine is further configured to generate a rendered document (RD) based on the ID and the second page number substituted for the reference in response to the first page number equaling the second page number.

16. The system of claim 15, wherein the ED is defined using an extensible markup language.

17. The system of claim 15, further comprising:
a user application configured to record an occurrence of a page break in the ED,
wherein the initial value is set based on the page break.

18. The system of claim 15, wherein the layout engine is further configured to:
modify, in response to the first page number equaling the second page number, the ED to include the second page number for the reference; and
generate a second RD for the ED using the second page number as the initial value.

19. The system of claim 15, wherein the convertor module, the layout engine, and the data structure are located on a page rendering device.

20. The system of claim 15, wherein the ED comprises a table of contends, and wherein the table of contends comprises the reference.
